(19) United States
(12) Patent Application Publication
(10) Pub. No.: US 2012/0201557 A1
(43) Pub. Date: Aug. 9, 2012

(54) IMAGE FORMING APPARATUS

(75) Inventor: Yoshiaki TANAKA, Shizuoka-ken (JP)

(73) Assignees: Toshiba Tec Kabushiki Kaisha, Tokyo (JP); Kabushiki Kaisha Toshiba, Tokyo (JP)

(21) Appl. No.: 13/362,726

(22) Filed: Jan. 31, 2012

Related U.S. Application Data
(60) Provisional application No. 61/440,379, filed on Feb. 7, 2011.

(51) Int. Cl. G03G 15/10

(52) U.S. Cl. 399/62

(57) ABSTRACT

According to one embodiment, an image forming apparatus includes: an image forming section including a developing device; a toner-cartridge holding section configured to detachably house a toner cartridge that stores a toner supplied to the developing device and includes a storage medium which stores information concerning the toner; a reading device configured to read the information stored in the storage medium; a toner detecting section configured to detect that the toner is supplied to the developing device; a toner-density comparing section configured to compare densities of the toner and a carrier after the detection by the toner detecting section; and a storage device configured to store information concerning use in the reading device and the storage medium if the toner-density comparing section determines that the toner density reaches a predetermined value.

### CROSS-REFERENCE TO RELATED APPLICATION

This application is based upon and claims the benefit of priority from the prior U.S. patent application Ser. No. 61/440,379, filed on Feb. 7, 2011, the entire contents of which are incorporated herein by reference.

### FIELD

Embodiments described herein relate generally to an image forming apparatus.

### BACKGROUND

In the past, in an image forming apparatus, a recording medium (an IC chip, an RFID, etc.) having stored therein data such as characteristics of a toner cartridge is provided in the toner cartridge and control of transfer, fixing, and the like is performed on the basis of the data.

For example, when a toner is exhausted in a developing device, indication for urging replacement of the toner cartridge is displayed on a display section of the image forming apparatus. A user removes the used toner cartridge from a main body of the image forming apparatus and inserts a new toner cartridge into the main body.

When the new toner cartridge is inserted, a shaft provided on the inside of the toner cartridge rotates. A spiral is formed on the shaft. The shaft rotates a predetermined number of times according to driving by a main body side motor, whereby an agitating action for a toner and a carrier in the cartridge is performed. A rotation detection sensor provided in the main body detects whether the agitating action is performed. If the agitating action is not normally performed, a message such as “please check the toner cartridge” is displayed on the display section.

When the new toner cartridge is inserted into the image forming apparatus in this way, the data stored in the storage medium of the toner cartridge is read out and stored in a memory on the image forming apparatus side.

However, the rotation detection sensor has to be provided to determine whether the agitating action is normally performed. Therefore, a setting space has to be secured and cost increases.

### DESCRIPTION OF THE DRAWINGS

FIG. 1 is an external view of an image forming apparatus according to an embodiment;

FIG. 2 is a part of a configuration diagram of a toner cartridge;

FIG. 3 is a part of a configuration diagram of the toner cartridge and an image forming section;

FIG. 4 is a block diagram of the image forming apparatus; and

FIG. 5 is a flowchart for explaining the operation of the image forming apparatus.

### DETAILED DESCRIPTION

In general, according to one embodiment, there is provided an image forming apparatus including: an image forming section configured to form an image under a predetermined control condition and including a developing device; a toner-cartridge holding section configured to detachably house a toner cartridge that stores a toner supplied to the developing device and includes a storage medium which stores information concerning the toner; a reading device configured to read the information stored in the storage medium; a toner detecting section configured to detect that the toner is supplied to the developing device; a toner-density comparing section configured to compare densities of the toner and a carrier after the detection by the toner detecting section; and a storage device configured to store information concerning use in the reading device and the storage medium if the toner-density comparing section determines that the toner density reaches a predetermined value.

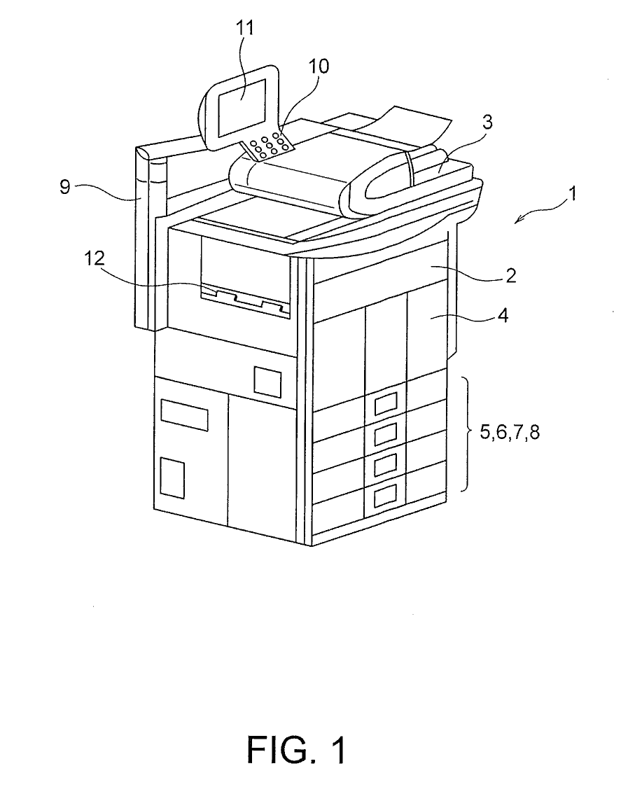

FIG. 1 is an external view of an image forming apparatus 1, which is a multi functional peripheral (MFP). The image forming apparatus 1 includes a box-like main body 2. An auto document feeder 3 is arranged on an upper surface of the main body 2. A cover 4 is provided in the front of the main body 2. Plural paper feeding cassettes 5, 6, 7, and 8 are provided below the cover 4 to be capable of being drawn out to the front side. An arm 9 is provided on the back of the main body 2. Operation keys 10 operated by a user and a display section 11 functioning as an informing device are supported by the arm 9. A sheet fed from any one of the paper feeding cassettes 5, 6, 7, and 8 is conveyed on the inside of the main body 2 and, after an image is printed thereon, discharged from a discharge port 12.

In the main body 2, as well-known components, a scanner section, an image forming section, a transfer section, and a fixing section are arranged. For example, the scanner section scans an original document conveyed from the auto document feeder 3 and creates image data. The image forming section forms an electrostatic latent image on a photoconductive member on the basis of the image data, develops the electrostatic latent image with a toner supplied from a developing device, and obtains a toner image. The transfer section transfers the toner image onto the sheet. The sheet having the toner image transferred thereon is conveyed to the fixing section. The fixing section fixes the toner image on the sheet. The sheet after the fixing is discharged to a paper discharge tray (not shown) from the discharge port 12.

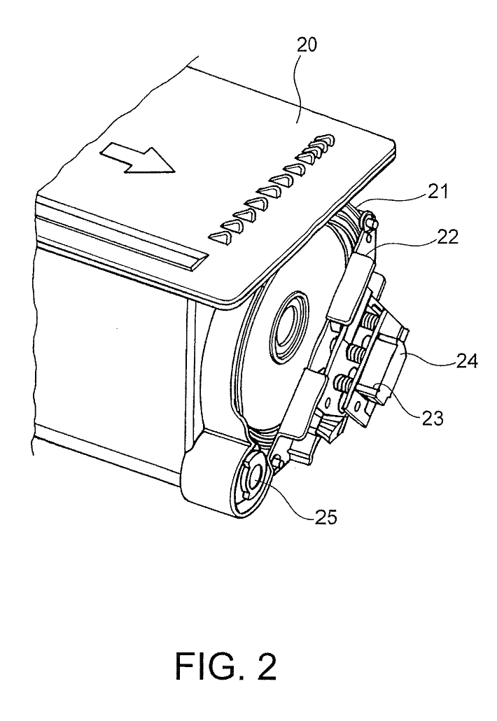

In this series of work, the developing device consumes the toner by developing the electrostatic latent image. The toner is supplied to the developing device from a toner cartridge 20 (see FIG. 2) that is arranged in the main body 2 and stores the toner.

FIG. 2 is an external view of the toner cartridge 20 partially cut away. As shown in FIG. 2, an IC chip 22 is provided on an outer wall on a removal side of a toner container 21 of the toner cartridge 20. Information stored in the IC chip 22 is, for example, history information of the toner and manufacture year, month, and date, a lot number, and a manufacturing place of the toner cartridge 20. The IC chip 22 having such history information is attached to the toner container 21 during manufacturing of the toner cartridge 20. A toner-cartridge-information acquiring section 23, which is a reading device for reading the IC chip 22, and a transmitting and receiving section 24 are provided in the main body 2 of the image forming apparatus 1. Further, an agitating shaft 25 that agitates the toner stored in the toner cartridge 20 is provided.

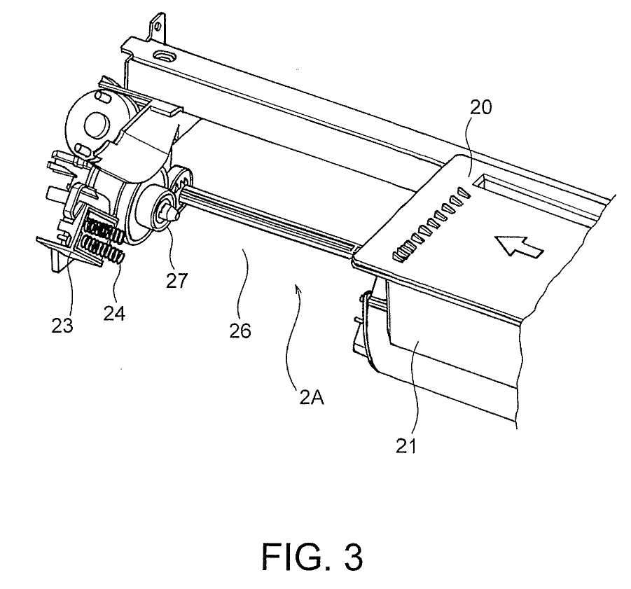

On the inside of the cover 4 of the main body 2, as shown in FIG. 3, a toner-cartridge holding section 26 is formed as a part of an image forming section 2A. The toner cartridge 20 can be removed from the toner-cartridge holding section 26. When the toner cartridge 20 is housed in the toner-cartridge holding section 26, the agitating shaft 25 and a fitting section 27 are coupled and an agitating action is performed.

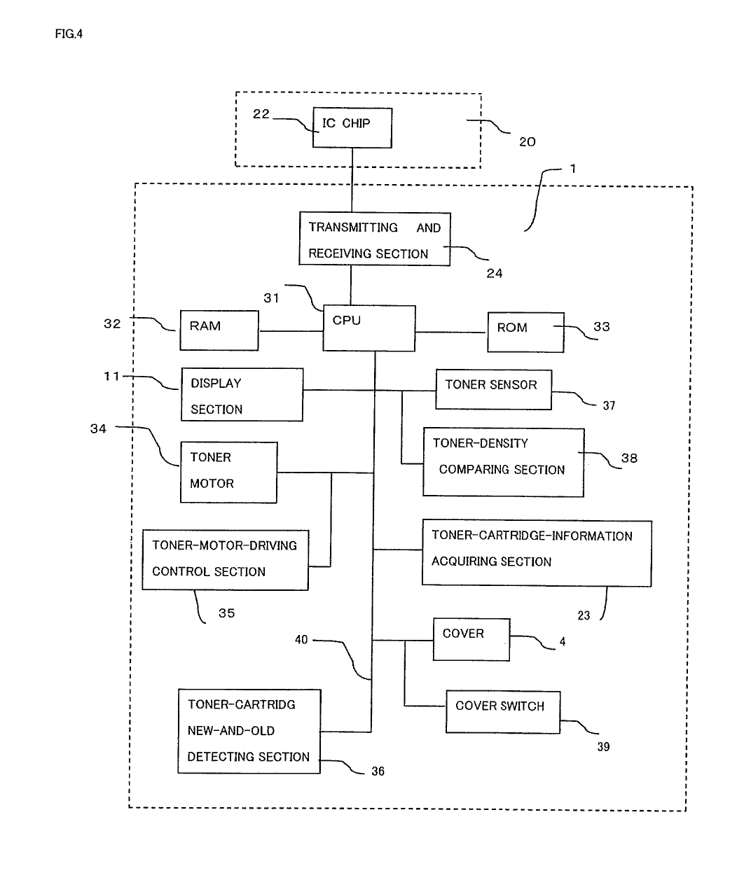

FIG. 4 is a block diagram of a component section where readout of data from the IC chip 22, which is a storage medium, of the toner cartridge 20 is performed. In the image forming apparatus 1, a control section configured to control the operation of the entire image forming apparatus 1 includes a combination of nonvolatile and volatile or magnetic storage devices such as a CPU 31, a RAM 32, a ROM 33, and a HDD. The CPU 31 performs an arithmetic operation, signal processing, and the like on the basis of a computer program, data, an input signal, and the like and controls the operation of the sections.

As shown in FIG. 4, the image forming apparatus 1 according to this embodiment includes the toner-cartridge-information acquiring section 23 configured to acquire information of the IC chip 22 functioning as the storage medium provided in the toner cartridge 20, a toner motor 34 for agitating the toner and a carrier in the toner cartridge 20, a toner-motor-driving control section 35 configured to control to drive the toner motor 34, a toner-cartridge new-and-old detecting section 36 configured to detect whether the toner cartridge 20 is new, a toner sensor 37 for detecting whether the toner is present in a not-shown developing device, a toner-density comparing section 38 configured to detect and compare the densities of the toner and the carrier of a two-component developer after the detection by the toner sensor 37, and a cover switch 39 configured to determine whether the cover 4 is opened or closed. These sections are connected to one another by a bus line 40 or the like. In the IC chip 22, the non-contact transmitting and receiving section 24 configured to transmit and receive the information stored in the IC chip 22 is set on the main body 2 side. The display section 11 plays a role of the informing device configured to perform display for urging the user to replace the toner cartridge 20.

In such a configuration, when the toner in the toner cartridge 20 is exhausted, a message such as “please replace the toner cartridge” is displayed on the display section 11 of the image forming apparatus 1. Before replacing the used toner cartridge 20 with a new one, the user performs work for shaking the new toner cartridge 20 for a few times. This is for the purpose of loosening the toner adhering in the toner cartridge 20.

The user opens the cover 4, removes the used toner cartridge 20, and inserts the new toner cartridge 20 into the toner-cartridge holding section 26. At this point, as shown in FIG. 3, the user inserts the toner cartridge 20 with a side of the toner cartridge 20 on which the IC chip 22 is provided set on the inner side. Finally, the user closes the cover 4.

When the cover 4 is closed, it is checked whether the IC chip 22 is present. If the IC chip 22 is absent, it is detected that the toner cartridge 20 is not a genuine product. A message such as “please check the toner cartridge” is displayed on the display section 11.

If the IC chip 22 is present, the toner-cartridge new-and-old detecting section 36 detects whether information of the IC chip 22 is new or old, i.e., whether the toner cartridge 20 is new or old. If the toner-cartridge new-and-old detecting section 36 determines that the information of the IC chip 22 is new, the toner motor 34 is driven and the fitting section 27 coupled to the toner motor 34 rotates. The fitting section 27 fits with the agitating shaft 25 of the toner cartridge 20. The toner in the toner cartridge 20 is agitated and conveyed and the toner is supplied to the developing device.

When a predetermined time elapses after the toner is supplied to the developing device, the toner-density comparing section 38 in the developing device detects the densities of the toner and the carrier. If the toner-density comparing section 38 determines, as a result of comparison of the densities, that the toner density reaches a predetermined value, the image forming apparatus 1 enters a standby state in which rewriting processing for storing the information of the IC chip 22 in the toner-cartridge-information acquiring section 23 is performed and printing information is sent to the toner-cartridge-information acquiring section 23. If the toner density does not reach the predetermined value, a message such as “please remove the toner cartridge and shake the toner cartridge a few times” is displayed on the display section 11.

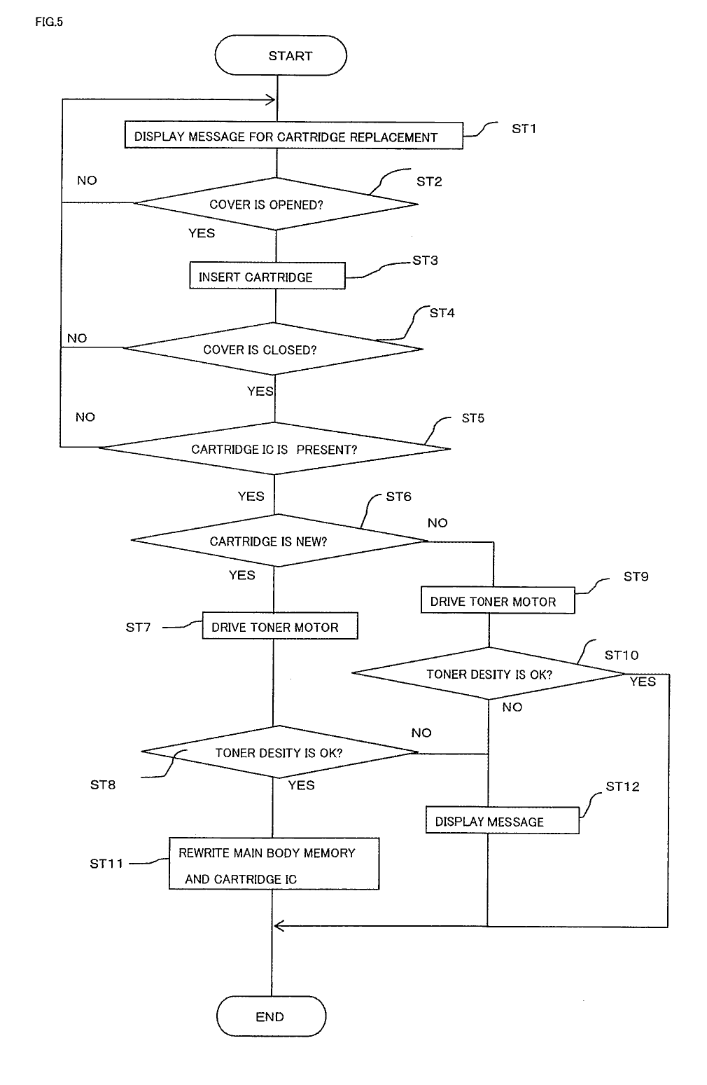

A flowchart of processing by the image forming apparatus 1 according to this embodiment is shown in FIG. 5. A form of detailed processing is explained according to the flowchart.

First, when the toner sensor 37 detects that the toner in the developing device is exhausted, in Act 1, a message for urging the user to replace the toner cartridge 20 is displayed on the display section 11. The user prepares the new toner cartridge 20. In Act 2, the user opens the cover 4 of the main body 2. The cover switch 39 detects that the cover 4 is opened (YES in Act 2). The user removes the used toner cartridge 20 from the toner-cartridge holding section 26. In Act 3, the user inserts the new toner cartridge 20.

Subsequently, in Act 4, the cover switch 39 determines whether the cover 4 is closed. If the cover 4 is closed (YES in Act 4), in Act 5, it is determined whether the IC chip 22 is present in the toner cartridge 20. If it is determined in Act 5 that the IC chip 22 is present (YES in Act 5), in Act 6, the toner-cartridge new-and-old detecting section 36 detects whether the toner cartridge 20 is new or old. If it is determined in Act 5 that the IC chip 22 is absent (NO in Act 5), the processing returns to Act 1. A message such as “please replace the toner cartridge” is displayed and the processing in Act 1 to Act 5 is repeated.

If the IC chip 22 is absent in Act 5 (NO in Act 5), it can be determined that the toner cartridge 20 is not a genuine product.

If the toner-cartridge new-and-old detecting section 36 determines in Act 6 that the inserted toner cartridge 20 is new (YES in Act 6), in Act 7, the toner-motor-driving control section 35 drives the toner motor 34 and the fitting section 27 coupled to the toner motor 34 rotates a predetermined number of times or for a predetermined time. Even if the toner-cartridge new-and-old detecting section 36 determines in Act 6 that the inserted toner cartridge 20 is not new (NO in Act 6), in Act 9, the toner-motor-driving control section 35 drives the toner motor 34. In the routine from Act 6 to Act 9, for example, the user uses the used toner cartridge 20 again after shaking and inserting the toner cartridge 20.

When the toner motor 34 rotates in Act 7 and Act 9, the agitating shaft 25 of the toner cartridge 20 fitting with the fitting section 27 also rotates. The toner in the toner cartridge 20 is supplied to the developing device by the agitating shaft 25.

In Act 8 and Act 10, the toner-density comparing section 38 provided in the developing device determines whether the toner supplied to the developing device and the carrier are sufficiently agitated. If the toner-density comparing section 38 determines that the toner and the carrier are not sufficiently agitated (NO in Act 8 and NO in Act 10), in Act 12, a message such as “please remove the toner cartridge and shake the toner cartridge a few times” is displayed on the display section 11 and the processing ends.

If the toner density reaches the predetermined value through the agitation of the toner and the carrier in Act 8 (YES in Act 8), in Act S11, the information of the IC chip 22 is stored in the toner-cartridge-information acquiring section 23, the replacement with the new toner cartridge 20 is stored in the toner-cartridge new-and-old detecting section 36, and the processing ends.

If the toner density reaches the predetermined value through the agitation of the toner and the carrier in Act 10 (YES in Act 10), the storage in the toner-cartridge-information acquiring section 23 and the toner-cartridge new-and-old detecting section 36 is not performed and standby for printing is performed.

In this way, even if a rotation detection sensor for detecting rotation driving for conveying the toner in the toner cartridge 20 to the developing device is not provided, detection of a normal agitating action for the toner and detection concerning whether the toner cartridge 20 is new or old are surely performed by the informing device.

In this embodiment, an example of a monochrome image forming apparatus is explained. However, the embodiment is not limited to this and may be applied to a color image forming apparatus. The embodiment may be realized by a standalone printer rather than a digital multi function peripheral.

While certain embodiments have been described, these embodiments have been presented by way of example only, and are not intended to limit the scope of the inventions. Indeed, the novel apparatus and methods described herein may be embodied in a variety of other forms: furthermore various omissions, substitutions and changes in the form of the apparatus and methods described herein may be made without departing from the spirit of the inventions. The accompanying claims and there equivalents are intended to cover such forms of modifications as would fall within the scope and spirit of the invention.

What is claimed is:

1. An image forming apparatus comprising:
an image forming section configured to form an image under a predetermined control condition and including a developing device;
a toner-cartridge holding section configured to detachably house a toner cartridge that stores a toner supplied to the developing device and includes a storage medium which stores information concerning the toner;
a reading device configured to read, when the toner cartridge is housed in the toner-cartridge holding section, the information concerning the toner stored in the storage medium of the toner cartridge;
a toner detecting section configured to detect that the toner is supplied from the toner cartridge to the developing device;
a toner-density comparing section configured to compare densities of the toner and a carrier after the detection by the toner detecting section; and
a storage device configured to store, if the toner-density comparing section determines that the toner density reaches a predetermined value, the information concerning the toner in the storage medium read by the reading device.

2. The apparatus according to claim 1, further comprising an informing device configured to display, if the toner-density comparing section determines that the toner density does not reach the predetermined value, a message on a display section of the image forming apparatus.

3. The apparatus according to claim 2, wherein the message displayed by the informing device is a message for urging a user to shake the toner cartridge.

4. An image forming apparatus comprising:
an image forming section configured to form an image under a predetermined control condition and including a developing device;
a toner-cartridge holding section configured to detachably house a toner cartridge that stores a toner supplied to the developing device and includes a storage medium which stores information concerning the toner;
a cover provided in the toner-cartridge holding section and configured to be openable and closable;
a cover detecting section configured to detect an opening and closing action of the cover;
a toner detecting section configured to detect that the toner is supplied to the developing device;
a toner-density comparing section configured to compare densities of the toner and a carrier when the toner detecting section detects that the toner is supplied after the cover detecting section detects that the cover is closed;
a reading device configured to read the information of the storage medium if the toner-density comparing section determines that the toner density reaches a predetermined value;
an informing device configured to display a message if the toner-density comparing section determines that the toner density does not reach the predetermined value; and
a storage device configured to store, if the toner-density comparing section determines that the toner density reaches the predetermined value, the information read by the reading device.

5. The apparatus according to claim 4, further comprising a toner motor configured to perform an agitating action for the toner in the toner cartridge when the cover detecting section detects that the cover is closed.

6. The apparatus according to claim 5, wherein, if the toner motor is not rotated, the informing device displays a message for urging a user to remove the toner cartridge.

7. The apparatus according to claim 5, further comprising a toner-density detecting section configured to detect density of the toner after the toner motor rotates.

8. The apparatus according to claim 6, wherein the message displayed by the informing device is a message for urging the user to shake the toner cartridge.

9. The apparatus according to claim 4, wherein the reading device does not start the reading of the storage medium unless the cover is not closed.

10. An image forming apparatus comprising:
an image forming section configured to form an image under a predetermined control condition and including a developing device;
a toner-cartridge holding section configured to detachably house a toner cartridge that stores a toner supplied to the developing device and include a storage medium which stores information concerning the toner;
a reading device configured to read, when the toner cartridge is housed in the toner-cartridge holding section, the information concerning the toner stored in the storage medium of the toner cartridge;
a toner detecting section configured to detect that the toner is supplied from the toner cartridge to the developing device;
a toner-density comparing section configured to compare densities of the toner and a carrier after the detection by the toner detecting section;
a toner-cartridge new-and-old detecting section configured to detect whether the toner cartridge is new or old; and
a storage device configured to store, if the toner-cartridge new-and-old detecting section detects that the toner cartridge is new and the toner-density comparing section determines that the toner density reaches a predetermined value, the information concerning the toner stored in the storage medium read by the reading device.
